(19) United States
(12) Patent Application Publication
(10) Pub. No.: US 2009/0210558 A1
(43) Pub. Date: Aug. 20, 2009

(54) SYSTEM AND METHOD FOR OPERATING A VIRTUAL PROFESSIONAL SERVICE ORGANIZATION

(76) Inventors: Bret K. Bocook, Palo Alto, CA (US); Douglas Smurr, Alexandria, VA (US)

Correspondence Address: PCT LAW GROUP, PLLC, 818 CONNECTICUT AVENUE, NW, SUITE 700, WASHINGTON, DC, 20006, US

(21) Appl. No.: 12/372,547

(22) Filed: Feb. 17, 2009

Related U.S. Application Data
(60) Provisional application No. 61/066,291, filed on Feb. 20, 2008.

(51) Int. Cl. G06F 17/30

(52) U.S. Cl. 710/3; 707/100; 707/10; 707/E17.014; 707/E17.044; 707/E17.032

(57) ABSTRACT

Systems, methods and computer program products for establishing and operating a virtual professional service organization are disclosed. In an aspect, a virtual, global law firm is provided to consumers having access to a personal computer or other terminal in communications with the Internet, such that attorneys are capable of responding to their legal needs via video conferencing, VoIP telephone, chat, electronic mail and other forms of remote communications over the Internet. The result is the provisioning of quick, cost-effective and quality legal services to under-served populations.

### CROSS-REFERENCE TO RELATED APPLICATIONS

This Application claims the benefit of, and is related to, Applicant's co-pending applications: U.S. patent application Ser. No. 12/008,243 (Attorney Docket No. 1001.01) titled, “System and Method for Facilitating the Establishment and Operations of a Professional Service Organization” filed on Jan. 9, 2008; and U.S. Provisional Patent Application No. 61/066,291 (Attorney Docket No. 1000.02) titled “System and Method for Operating a Virtual Professional Service Organization,” filed on Feb. 20, 2008; each of which is incorporated by reference herein in its entirety.

### BACKGROUND OF THE INVENTION

1. Field of the Invention

The present invention generally relates to operating a professional service entity, and more particularly to systems, methods and computer program products for establishing and conducting the operations of such entities via virtual techniques.

2. Related Art

The period of 1995-2001, known as the “dot-com bubble”, was marked by the founding of a group of new Internet-based companies commonly referred to as “dot-coms.” Many of these companies sought to replace traditional store front (or “old economy” or “bricks and mortar”) businesses with online business models as access to the Internet increased and networking-related technology improved. Accordingly, this period also saw venture capitalist pour billions of dollars into such new Internet-based companies. Such companies included B2B e-commerce sites, B2C e-commerce sites, C2C e-commerce (e.g., auction) sites, social networking services sites, financial services sites, e-learning sites and the like.

Despite the above, professional service entities (e.g., legal, engineering, medical, chiropractic, accounting, architectural and like regulated, professional service firms) remained mostly traditional (or “old economy”). For example, there is currently no global law firm providing legal services online. This is despite the fact that the global legal market is worth US$293 billion annually (and the United States makes up 61% of the worldwide legal market). Further, in 2006, approximately 1.086 billion people used the Internet worldwide, representing only approximately 16% of the world's population. (Interestingly, it is estimated that some 70% of Americans have Internet access.) And, between 2000-2006, there has been over 200% growth in the number of American Internet users, 479% in the number users in Asia, and 625% in the number of users in Africa.

Despite the foregoing, previous virtual or online legal offerings have only consisted of the following categories of legal-related sites: (1) Online attorney matching services such as LegalFish, LegalMatch, and Casepost; (2) attorney referral services that have Web portals; (3) online legal “self-help” services such as LegalZoom; (4) traditional law firms who have informational Web sites (and which sometimes provides a forum for sharing documents with existing clients); and (5) laws, regulations and/or judicial decision database sites such as LexisNexis and Westlaw.

Further exasperating the problems identified herein is what is known as the “justice gap”—the well-documented inability of low-income, incarcerated and rural populations to get access to basic legal services. Thus is not surprising given that starting salaries for first-year attorneys at the nation's largest law firms are now north of $150,000 per year. Consequently, private law firms' billing rates ($250-$1000/hour) make receiving quality legal services beyond the reach of many segments of the population. Besides the high cost of traditional legal services (including the common practice of up-front cash retainers), the intimidation of going into a law firm, the difficulty of finding a qualified attorney, and many attorneys' unwillingness to handle issues or cases below a certain value threshold (e.g., below $10,000) due to the malpractice and collections risks have all contributed to a large segment of the population unable to retain qualified legal counsel.

Given the foregoing, what are needed are systems, methods and computer program products for operating a virtual professional service organization such that a (global) law firm providing legal services online and an efficient in inexpensive manner is made feasible.

### BRIEF DESCRIPTION OF THE INVENTION

The present invention meets the above-identified needs by providing systems, methods and computer program products for operating a virtual professional service organization.

In an aspect, the present invention provides a system for operating a virtual professional service organization comprising: a plurality of users each having access to a personal computer or other terminal in communications with the Internet; a Web server capable of displaying graphical user interface screens at one or more Web sites in response to input from the plurality of users; and a plurality of attorneys capable of responding to the legal needs of the plurality of users via video conferencing, VoIP telephone, chat and electronic mail (email) communications over the Internet, along with encryption technology to ensure client confidentiality necessary for attorney-client communications; wherein the Web server is operated by an entity facilitating the provisioning of a virtual law firm such that the plurality of users are able to obtain quick, cost-effective and quality legal services despite their respective physical locations in relation to the respective physical locations of the plurality of attorneys.

An advantage of the present invention is that it takes full advantage of the Internet's localizing effect on the global community by establishing “local virtual offices” where consumers may seek legal services that have previously been unavailable to them.

Another advantage of the present invention is that an entity adopting aspects of it may implement order processing and data management systems to optimize the sales process and increase the rate at which customers actually pay for services rendered with minimal capital expenditure.

Another advantage of the present invention is that an entity employing it will be able to offer efficient, economical, rapid, accurate, reliable and accessible professional services to consumers and businesses thereby achieving high levels of customer satisfaction.

Another advantage of the present invention is that it allows law firms to implement a new, more efficient and economical paradigm for conducting business transactions and communications between professionals and clients, and between professionals and professionals.

Another advantage of the present invention is that it allows traditional law firms to attract new clients and perform business development through proven “dot com” marketing techniques such as advanced keyword research to identify search phrases used by potential clients, pay-per-click advertising on various popular search engine sites (e.g., Google, Yahoo!, MSN, Ask.com, etc.), building links through press releases and other tactics to increase organic search engine page rankings, and the ability to track Web site traffic through state of the art analytics software (e.g., Google Analytics).

Yet another advantage of the present invention is that it combines a virtual professional services firm (e.g., a law firm) using the latest networking and other computing and communications technologies with traditional legal practices to provide a full service global law firm to clients anywhere in the world.

Another advantage of the present invention is that it allows consumers to have the ability to harness one or more highly-specialized attorneys—who may practice at separate “brick and mortar” law firms—who are remotely located via the Internet to solve their problems in a more specialized and efficient manner.

Yet another advantage of the present invention is that it allows handicapped and other persons who may not be able to get to a law firm to have access to legal services, and with savings achieved through economies of scale it provides access to lawyers for low income customers that are presently disenfranchised.

Yet another advantage of the present invention is that it allows a law firm or a network of affiliated law firms to obtain and service clients who previously had difficulty obtaining quality and affordable legal services.

Further features and advantages of the present invention, as well as the structure and operation of various aspects of the present invention, are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a block diagram of an exemplary system for facilitating the establishment and operations of a professional service firm according to an aspect of the present invention.

FIG. 2 is a block diagram of an exemplary computer system useful for implementing the present invention.

FIGS. 3A-3B are flowcharts depicting an aspect of the operation and control flow of the tool of the present invention.

FIGS. 4A-D are exemplary windows or screen shots generated by the graphical user interface of the present invention.

### DETAILED DESCRIPTION

The present invention is directed to systems, methods and computer program products for establishing and operating a virtual professional service organization offering professional (e.g., legal, engineering, medical, chiropractic, accounting, architectural and the like) services. A unique business structure for professional entities allowing them to implement the systems, methods and computer program products of the present invention is described in detail in Applicants' co-pending U.S. patent application Ser. No. 12/008,243 (Attorney Docket No. 1000.01), titled “System and Method for Facilitating the Establishment and Operations of a Professional Service Organization”, filed on Jan. 9, 2008, which is hereby incorporated by reference herein in its entirety.

In an aspect of the present invention, a law firm or a network of affiliated law firms engage in attorney-client relationships online by utilizing an online tool for establishing and operating a virtual professional service organization. In such an aspect, the firm or affiliated firms may service clients (whether individuals, small-, medium- and large-sized businesses, etc.) using both “brick and mortar” offices and virtual offices, while offering extremely competitive rates to a broader spectrum of clients. Thus, for a large segment of the population, legal advice is now available at the click of a mouse for a full range of legal problems from small scale to high value with pre-qualified attorneys, and easy payment via credit card, debit card, PayPal, Google Checkout, mobile telephone and like non-cash, online payment methods.

The present invention is now described in more detail herein in terms of the above exemplary legal professional services context. This is for convenience only and is not intended to limit the application of the present invention. In fact, after reading the following description, it will be apparent to those skilled in the relevant art(s) how to implement the following invention in alternative aspects (e.g., engineering, medical, chiropractic, accounting, architectural and like regulated, professional service firms).

The terms “entity,” “organization,” “firm,” “company,” “business,” “individual” and/or the plural form of these terms are used interchangeably throughout herein to refer to those person(s) or entity(ies) offering professional (e.g., law, engineering, medical, chiropractic, accounting, architectural, etc.) services and would benefit from the system and method that the present invention provides for facilitating the establishment and operations of such entities.

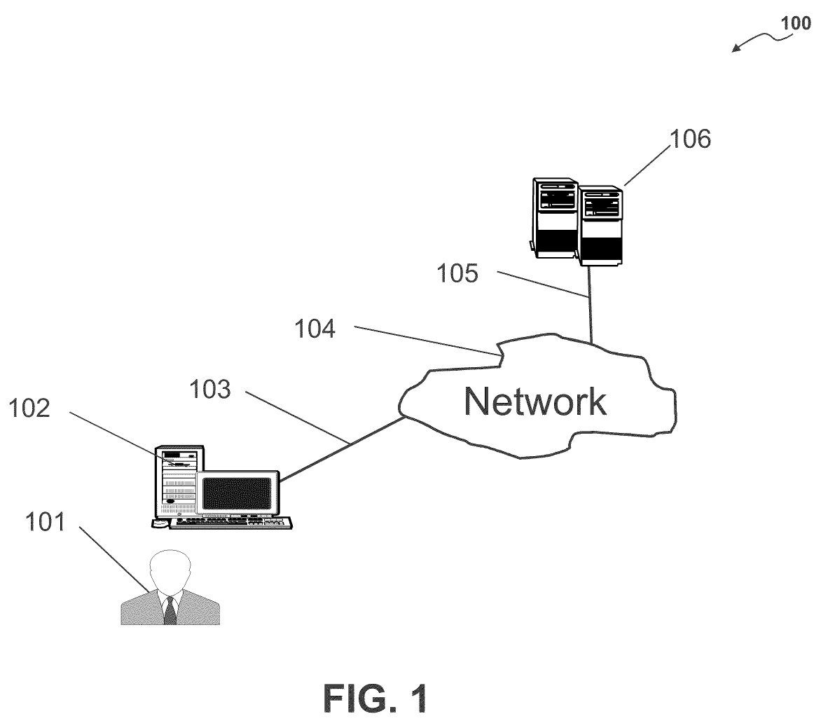

FIG. 1 presents an exemplary system diagram 100 of various hardware components and other features in accordance with an aspect of the present invention. As shown in FIG. 1, in an aspect of the present invention, data and other information and services for use in the system are, for example, input by a user (i.e., client) 101 via a terminal 102, such as a personal computer (PC), minicomputer, laptop, palmtop, mainframe computer, microcomputer, telephone device, mobile device, personal digital assistant (PDA), or other device having a processor and input and display capabilities. Terminal 102 is coupled to a server 106, such as a PC, minicomputer, mainframe computer, microcomputer, server computer, or other device having a processor and a repository for data or connection to a repository for maintaining data (i.e., one or more databases), via a network 104, such as an internet, intranet or the global, public Internet, via couplings 103 and 105.

As will be appreciated by those skilled in the relevant art(s) after reading the description herein, in such an aspect, a service provider may allow access, on a free registration, paid subscriber and/or pay-per-use basis, to the tool via one or more World-Wide Web (WWW) sites on the Internet 104. Thus, system 100 is scaleable such that multiple law firm offices may utilize it to allow their clients to submit, review, screen, and generally interact with them similar to traditional attorney-client relationship communications.

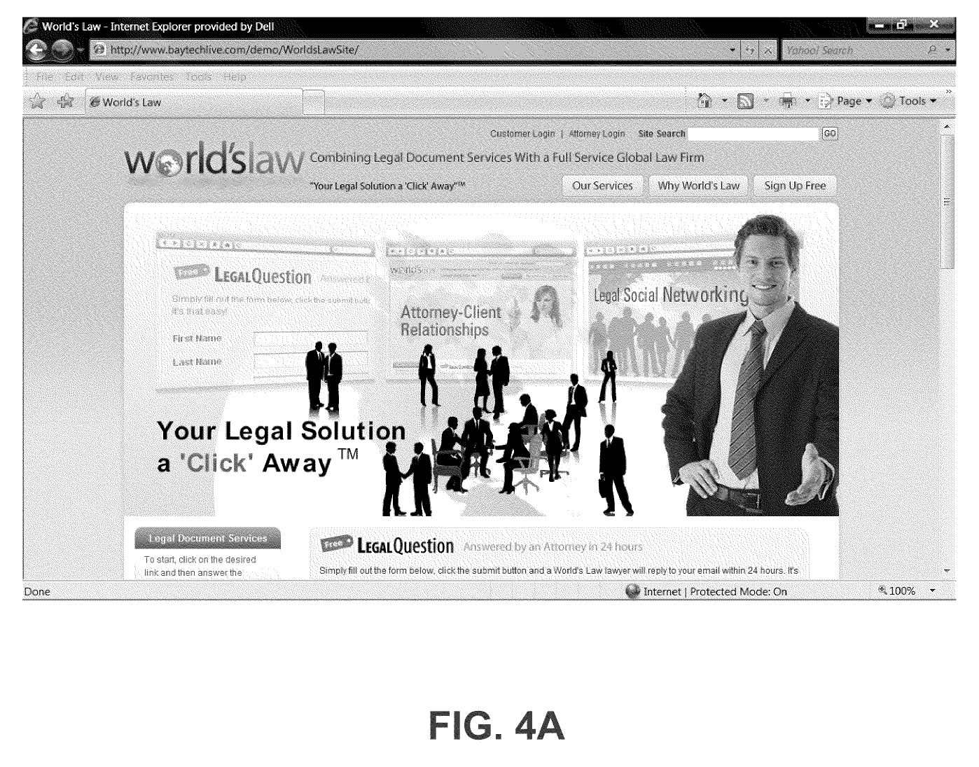

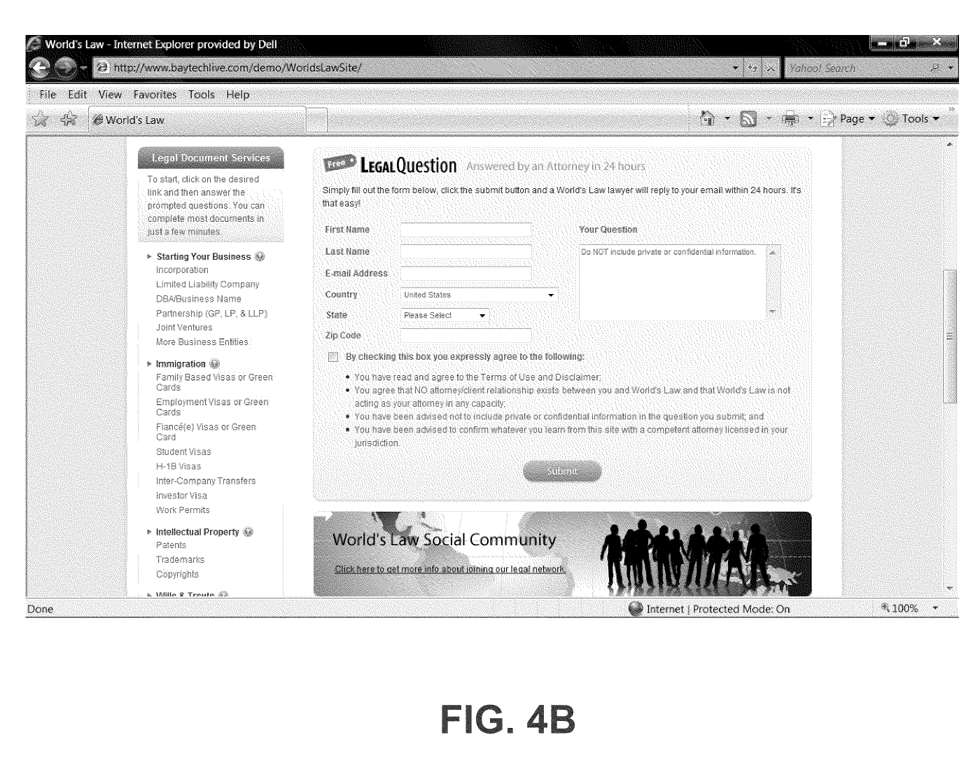

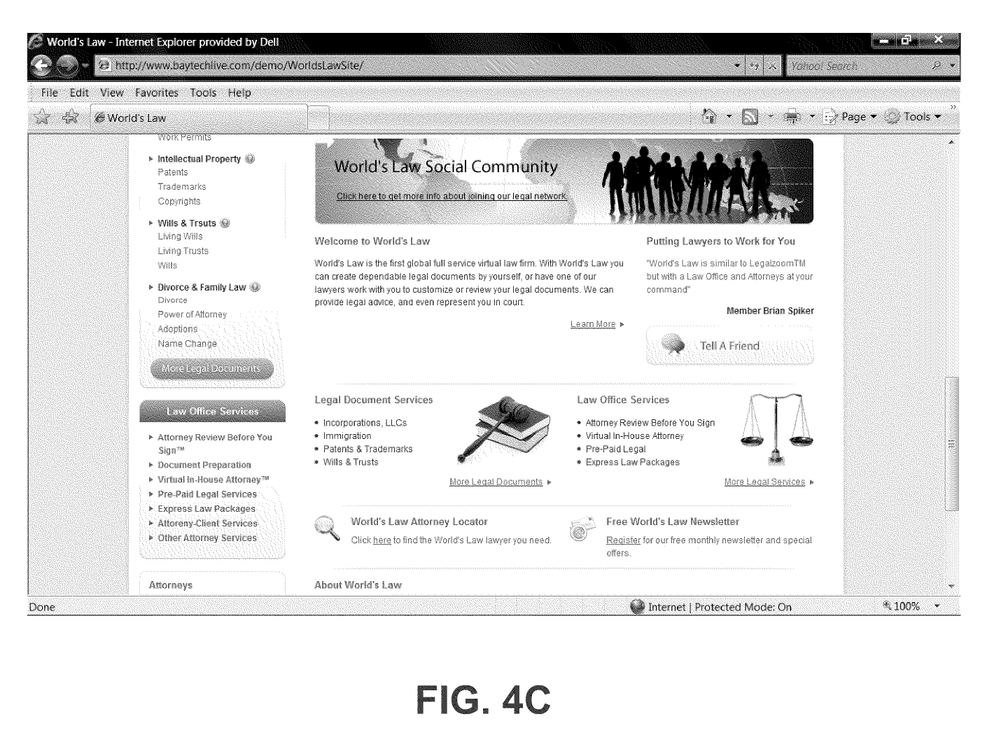

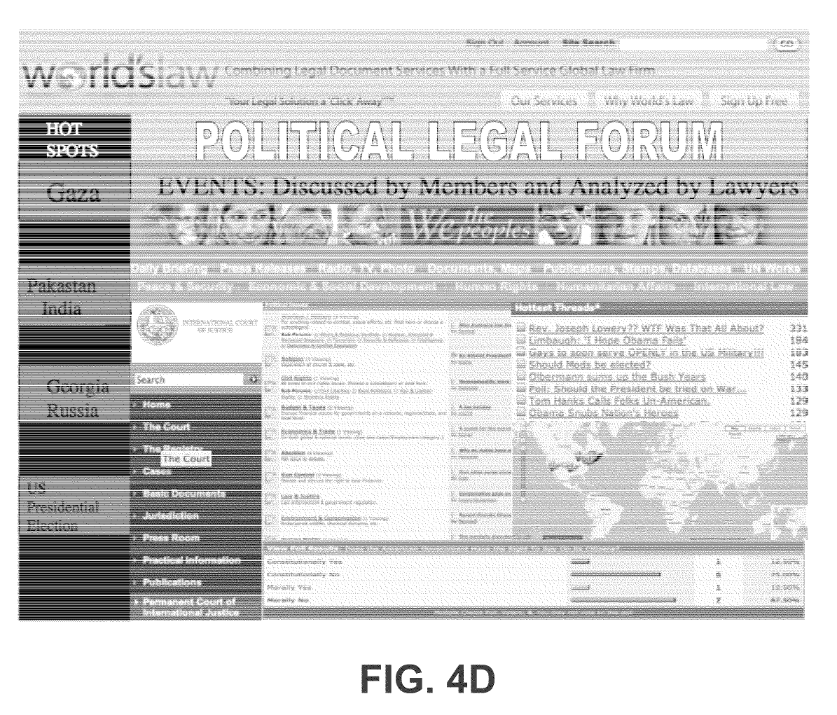

As will also be appreciated by those skilled in the relevant art(s), in an aspect, various (login, admin, account, information, resource, logout, payment, registration, communications, etc.) screens would be generated by server 106 in response to input from user 101 over the Internet 104. That is, in such an aspect, server 106 is a typical Web server running a server application at a Web site which sends out Web pages (shown in FIGS. 4A-D) in response to Hypertext Transfer Protocol (HTTP) or Hypertext Transfer Protocol Secured (HTTPS) requests from remote browsers being used by users 101. Thus, server 106 is able to provide a graphical user interface (GUI) to users 101 of system 100 in the form of Web pages. These Web pages sent to the user's PC, laptop, mobile device, PDA or the like device 102, and would result in the GUI screens of FIGS. 4A-D being displayed.

In alternate aspects, various components of system 100 may be, for example, software programs or other applications or devices that execute programs in association the operation of system 100. Such components may be programmed in any of a variety of suitable programming languages, such as C++, C, Java, HTML, PHP, and/or a variety of other kinds of software programming/scripting languages that may be applied to create instructions in accordance with aspects of the invention.

As will also be appreciated by those skilled in the relevant art(s) after reading the description herein, alternate aspects of the present invention may include providing the tool for operating a virtual professional service organization as a stand-alone system (e.g., installed on one PC) or as an enterprise system wherein all the components of system 100 are connected and communicate via an inter-corporate wide area network (WAN) or local area network (LAN), rather than as a Web service (i.e., application service provider (ASP) model) as shown in FIG. 1.

The present invention (i.e., system 100, process 300 (described below), the methods of facilitating the establishment and operations of a professional services firm of the present invention, or any part(s) or function(s) thereof) may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

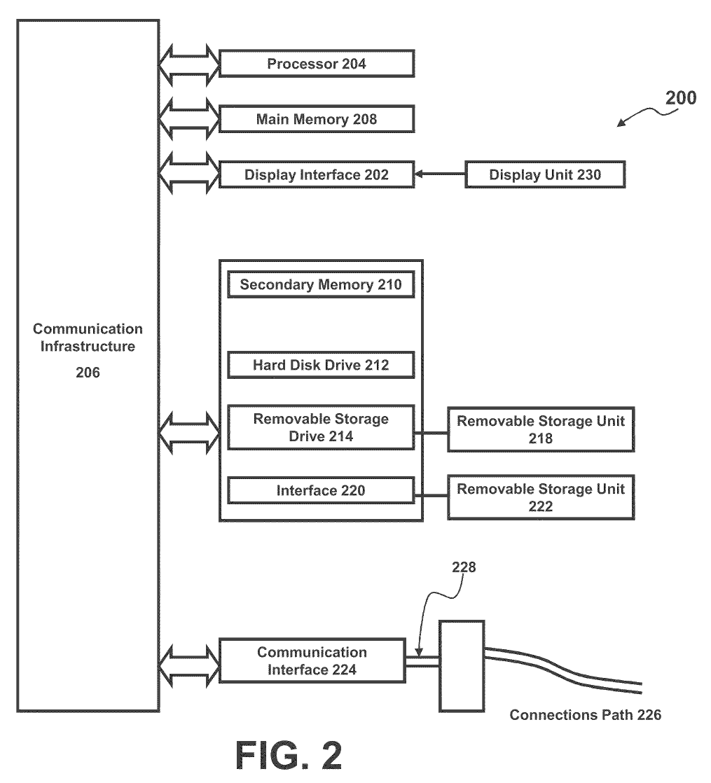

In fact, in one aspect, the invention is directed toward one or more computer systems capable of carrying out the functionality described herein. An example of a computer system 200 is shown in FIG. 2.

Computer system 200 includes one or more processors, such as processor 204. The processor 204 is connected to a communication infrastructure 206 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230.

Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well known manner. Removable storage unit 218 represents a floppy disk, magnetic tape, optical disk, etc. which is read by and written to by removable storage drive 214. As will be appreciated, the removable storage unit 218 includes a computer usable storage medium having stored therein computer software and/or data.

In alternative aspects, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228 which may be electronic, electromagnetic, optical or other signals capable of being received by communications interface 224. These signals 228 are provided to communications interface 224 via a communications path (e.g., channel) 226. This channel 226 carries signals 228 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 214, a hard disk installed in hard disk drive 212, and signals 228. These computer program products provide software to computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an aspect where the invention is implemented using software, the software may be stored in a computer program product and loaded into computer system 200 using removable storage drive 214, hard drive 212 or communications interface 224. The control logic (software), when executed by the processor 204, causes the processor 204 to perform the functions of the invention as described herein.

In another aspect, the invention is implemented primarily in hardware using, for example, hardware components such as application specific integrated circuits (ASICs). Implementation of the hardware state machine so as to perform the functions described herein will be apparent to persons skilled in the relevant art(s).

In yet another aspect, the invention is implemented using a combination of both hardware and software.

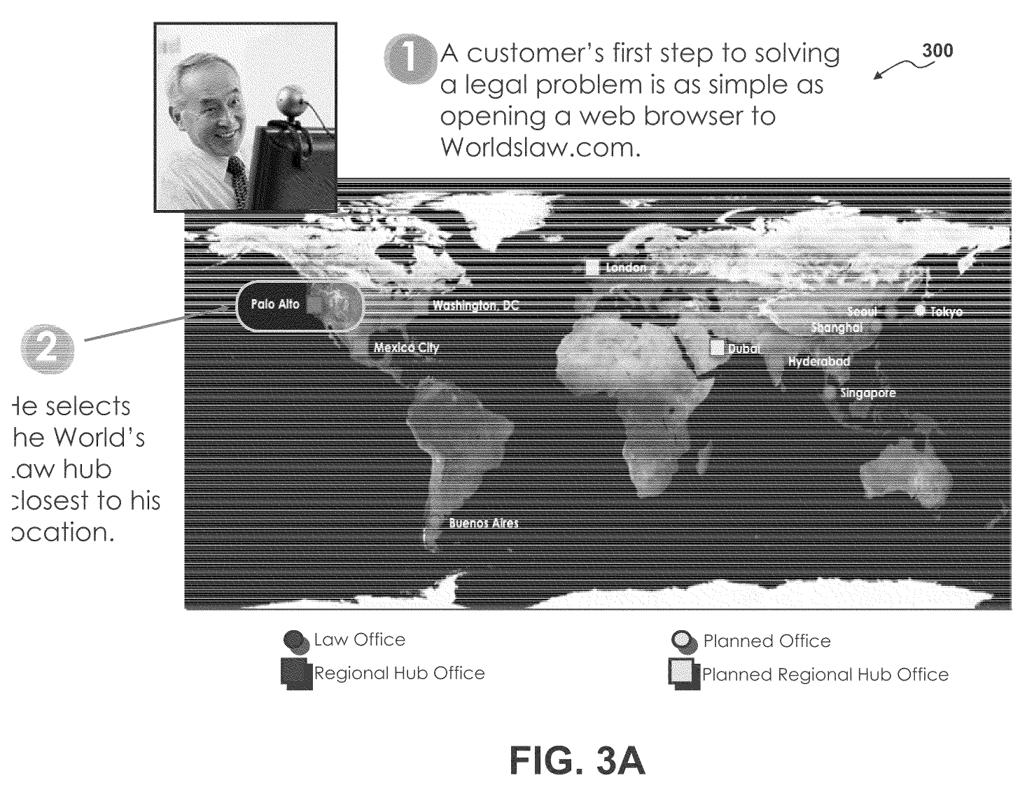

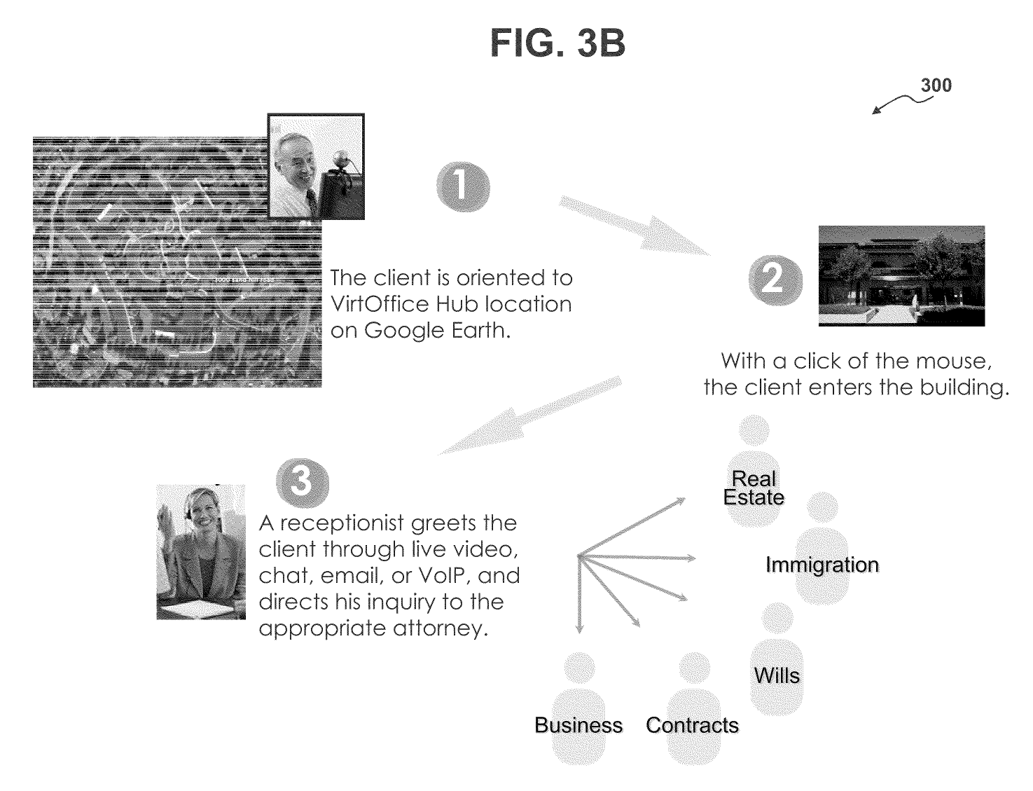

Referring to FIGS. 3A-B, flowcharts depicting aspects of the operation and control process 300 of the tool of the present invention are shown. Process 300, in alternate aspects, is structured and designed for a fully virtual existence by employing the power of the Internet in the following manner:

(1) A user (i.e., a law client, prospective client or fellow legal professional) accesses a Web site using a PC or other terminal device 102 via the Internet 104 and is then welcomed by a virtual receptionist through a GUI screen. The user then selects a “virtual office” location from an index, 3D visual map or the like. Upon making a selection, the user then “enters” the virtual office environment through a GUI provided by a virtual globe program (such as Google Earth, Microsoft Live Search Maps, NASA WorldWind, and the like) that superimposes images obtained from satellite imagery, aerial photography and 3D geographical information system (GIS) globe. By using a virtual globe program, the user will “fly” to their virtual office destination as a virtual 3D experience replicates the physical entering of a street, building and office where a receptionist then may greet the user.

(2) Upon entering the virtual office, the user can be presented with a real-life (i.e., non-virtual) receptionist who would welcome the user to a virtual waiting room as if the user was in a traditional office. Thereafter, the receptionist assesses the needs of the user. The present invention aims to virtually replicate the manner in which one selects a professional in the physical, real-world environment either through a telephone conversation or by walking into an office. Even though the user may engage the receptionist from within a virtual environment through a combination of pre-recorded and live video feed experiences, the user will feel as though they are in a real-life personal meeting, but from the comfort of their location (and device 102). In alternate aspects of the present invention, the receptionist may communicate with the user via video conferencing, email, text chat, video chat, telephone/VoIP calls and the like.

(3) Upon assessing the needs of the user, the receptionist directs the user to an appropriate and available attorney. A real-life attorney will then greet the user, in the virtual waiting room and through a combination of pre-recorded and live video feed experiences will walk the user back to his/her office by utilizing the virtual globe program GUI. The attorney will ask the user to “sit down in the client chair,” and then the attorney will sit down in his/her chair to begin the meeting—which is virtual with live video conversations. The user will feel and experience that s/he is in a real face-to-face meeting within the virtual environment, although they are remotely located. If the appropriate attorney is not available at the moment, an appointment will be made for the user setting a date and time. Additionally, the user's request may be placed in a queue such that the attorney may contact the user once they become available. The attorney can initiate such contact though a telephone call, email or a “ping” via a chat or instant messaging system (e.g., by using the Skype system, Apple's iChat, Yahoo! messenger, Google Talk, Windows Live Messenger or the like, all utilizing the built-in cameras that are now prevalent on today's PCs) at a time convenient to the user.

(4) The user and attorney will carry on a virtual meeting via video conference while the attorney is in their real, physical office and while the user attends the meeting from the comfort of his/her location (and device 102). Multiple professionals or users could participate in such a meeting through the overlay of video conferencing, email and the like.

(5) In an aspect, the attorney may recommend the user complete certain documents that may be from a Web page that displays a library of legal documents stored in a repository associated with server 106. Such documents can then be selected and modified by the attorney and client working together to meet the specific needs of the user. In such an aspect, drafts of documents may be passed back and forth (while utilizing encryption technology) via email or a secure, online document collaboration system (e.g., Google Docs) until a complete and final document (or set of documents) that meets the user's needs is completed.

(6) In the foregoing steps of process 300, neither the user nor the attorney may have to leave the comfort of their home/office while conducting business. In an aspect, the virtual environment will be replete with the normal physical appearance that one would find in a “brick and mortar” law firm office, such as virtual pictures of the attorney's actual diplomas, bar licenses, artwork, furniture and every other physical trait that conforms to what a user or other professional would expect from visiting such professional offices.

As will be appreciated by those skilled in the relevant art(s) after reading the description herein, an operator of system 100 that is implementing process 300 would assure that there is a global network of real-life attorneys that are “associated” with the service provider to form a “virtual law firm” and assure such an arrangement is ethically compliant in each of the jurisdictions in which it operates.

In alternate aspects, the user may be billed hourly, or may select from packages that include: email responses to questions, video conferencing, telephonic communications, chat, texting, or a combination thereof. In an aspect, corporate entities may pay a monthly or yearly flat-fee for unlimited access to system 100 (i.e., a “virtual in-house counsel” service), that will provide access to an attorney 24/7. Furthermore, a user has the option to be assigned to a particular attorney to create a consistent “virtual professional relationship” to enhance trust and intimacy of the attorney-client relationship.

In alternate aspects of the present invention, the attorneys of the law firm or affiliated firms implementing the tool of system 100 may use a variety of communication tools to work with their respective clients and potential clients. Such tools include traditional face-to-face meetings, email, telephone (traditional, mobile or VoIP), chat (e.g., IRC, MSN Messenger, Google Talk and the like) and video conferencing (e.g., EarthLink Conference Manager, iVisit, Webex, Cisco TelePresence and the like, that allow meetings to be convened with people participating from anywhere in the world). As will be appreciated by those skilled in the relevant art(s) after reading the description herein, the GUI of system 100 may be offered in multiple languages and at multiple Web sites to allow cross-border legal consultations or allow immigrant consumers to use their native language while seeking legal consultations. In such an aspect, attorney-client communications would employ translation technology to allow attorneys and clients speaking different languages to communicate. In an alternate aspect, communications during process 300 are facilitated, at least in part, by the COCO™ Protocol developed by CoCo Communications Corp. of Seattle, Wash., and as described in United States Patent Application No. 2006/0053223 A1, which is incorporated herein by reference in its entirety.

As will be appreciated by those skilled in the relevant art(s) after reading the description herein, an entity operating system 100 may offer access in a number of pre-packaged alternatives. For example:
A $25 Package includes: 1 email inquiry; and minimum 100-word reply from an attorney (licensed in a selected jurisdiction) within two business days after receipt of payment.
A $100 Package includes: 1 email inquiry; and minimum 300-word reply from an attorney within two business days after receipt of payment.
A $300 Package includes: 1 email inquiry; 30 minutes of personalized legal research; and minimum 300-word reply from an attorney within two business days after receipt of payment.
A $500 Package includes: 2 email inquires; 5 hours of personalized attorney legal research; minimum 500-word reply from an attorney; and 30-minute video conference, telephone call, or chat session with an attorney.
A $1,000 Package includes: 3 email inquiries; 2 hours of personalized legal research; minimum 1,000-word reply from an attorney; and 1 hour video conference or telephone call.
A $2,000 Package includes: Unlimited email inquiries for two months; 3 hours of personalized legal research; minimum 2,000-word reply from an attorney (i.e., a full legal brief); 1 hour video conference or telephone call; and 2 hours of document preparation or legal review.
A $5,000 Package includes: Unlimited email inquiries for 3 month period; 50 hours of personalized attorney legal research; minimum 3,000-word reply—a full legal brief, unlimited video conferences, telephone calls, or chat sessions with an attorney for 3 months; and 4 hours of document preparation or legal review.

As will be appreciated by those skilled in the relevant art(s), after reading the description above, aspects of the present invention solve many common problems that plague the legal industry in the United States.

For example, typical law firms charge clients a retainer for the privilege of being able to sit down with the firm's attorneys to discuss a case in depth. This is a major inconvenience to consumers. First, a consumer would need to qualify and determine what law firm from which to seek a consultation. Then, the consumer has to find a lawyer who handles the area of law touching upon their legal issue, which can be difficult. Then, the consumer has to set an appointment, take the time and resources necessary to get to the appointment (e.g., drive or take public transportation). Getting to a physical law office may especially be difficult for the poor, rural, elderly, disabled and troops stationed in a battle zone. Further, given that many people have limited knowledge of their rights, many people will just decide not to go through this hassle. Once a consumer even gets an appointment, only a short discussion with an attorney is made available to them before having to actually pay for services. This is typically not enough time to figure out if there exist a legal remedy, cause of action or solution to their perceived legal need. This is in addition to having to determine whether the consumer likes the attorney and wants to do business with them.

Aspects of the present invention as described above, however, meet the above-identified need, by providing the ability for a consumer—who is curious as to whether they have a legal remedy, cause of action or solution to their perceived problem—to access a Web site operated by an entity providing system 100 and: (1) submit an email inquiry to an attorney; (2) attend a video conference or chat online with an attorney without having to leave their home (at a fraction of the cost of going to the trouble of driving to a physical law office); and (3) have the attorney make an initial determination as to whether the consumer actually has a legal remedy, cause of action or solution to their perceived problem, and take initial steps to solve the problem without having a face-to-face meeting.

In an alternate aspect of the present invention, the Web site provided by web server 106 may include a (free) social networking service component such that users (i.e., law clients) 101 may build one or more online communities of people, similar to MySpace, Facebook, Tagged, Xing and the like, who share common legal interests. In such an aspect, the social networking service component may be added to the Web site using the Clearspace Community software publically available from Jive Software of Portland, Oreg.

In an alternate aspect, the Web site provided by web server 106 may include a “wiki”-type component—organized into a topical, jurisdictional and geographical taxonomy—such that users 101 (both potential clients and attorneys) may collaborate to pose and answer legal questions. As will be appreciated by those skilled in the relevant art(s), a wiki-type collaborative Web site would allow users 101, using a Web browser, to easily edit, delete or modify legal-related questions and answer content that has been placed on the site, including the work of other users 101. In such an aspect, a wiki according to the present invention may have a map-based graphical user interface to allow client-users 101 to pose a legal question and have such a question appear on the map-based graphical user interface to indicate the geographical origin of the question and the language in which the question was posed. Then, in such an aspect, one or more attorney-users 101 who are licensed to practice in the geographical region from which the question originated, who have expertise in the relevant legal field, and speak the same language in which the question was posed, may answer the question. In alternate aspects, such a functionality may be provided for free or on a subscription or pay-per-use basis.

In an alternate aspect of the present invention, the operator of system 100 may offer educational, on-demand videos to users 101. Such videos (either provided for free or for a fee) would allow users, to learn their legal rights before engaging an attorney in order to become a better informed client. For example, a user 101 may view and on-demand video covering the basics, advantages, and disadvantages of forming an LLC versus an S Corporation. In such an aspect, a searchable database would store all available videos based on subject and geographic locality taxonomy. Each of such videos may be recorded by one or more law professors, expert practicing attorneys and/or legal correspondents to form a distance education or “Web TV”-type component of system 100.

In yet another alternate aspect of the present invention, the operator of system 100 may offer news-based forums to users 101. For example, the Web site provided by web server 106 may include a component where legal issues surrounding political “hot topics” are capable of being discussed and analyzed by users 101 (both potential clients and attorneys) as shown in FIG. 4D.

While various aspects of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary aspects.

Variations, modifications, and other implementations of what is described herein will occur to those of ordinary skill in the relevant art(s) without departing from the spirit and scope of the invention as claimed. Accordingly, the invention is to be defined not by the preceding illustrative description but instead by the spirit and scope of the following claims.

In addition, it should be understood that the figures in the attachments, which highlight the structure, methodology, functionality and advantages of the present invention, are presented for example purposes only. The present invention is sufficiently flexible and configurable, such that it may be deployed and implemented in ways other than that shown in the accompanying figures.

Further, the purpose of the foregoing Abstract is to enable the U.S. Patent and Trademark Office and the public generally, and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present invention in any way.

What is claimed is:

1. A method for operating a virtual professional service organization, comprising:
(a) providing, over a network, a graphical user interface to a plurality of users;
(b) receiving an input from one of said plurality of users, over said network and via said graphical user interface, said input indicative of at least a legal field and a jurisdiction;
(c) searching a database containing information about a plurality of attorneys, wherein the results of said searching is at least one of said plurality of attorneys licensed in said jurisdiction and having expertise in said legal field; and
(d) facilitating communications, over said network and via said graphical user interface, between said one of said plurality of users and said one of said plurality of attorneys;
wherein the provisioning of a virtual law firm, such that said plurality of users are able to receive legal services despite their respective physical locations in relation to the respective physical locations of said plurality of attorneys, is achieved.

2. The method of claim 1, wherein said network is at least a portion of the global, public Internet.

3. The method of claim 2, wherein communications between said one of said plurality of users and said one of said plurality of attorneys is via at least one of: video conferencing, VoIP telephone; chat; and email.

4. A system for operating a virtual professional service organization, comprising:
a server capable of displaying a plurality of graphical user interface screens at one or more Web sites in response to input from a plurality of users;
a database storing information about a plurality of attorneys capable of responding to the legal needs of said plurality of users; and
a network capable of facilitating communications between said server and said plurality of users and said plurality of attorneys;
wherein said server is operated by an entity facilitating the provisioning of a virtual law firm such that said plurality of users are able to receive legal services despite their respective physical locations in relation to the respective physical locations of said plurality of attorneys.

5. The system of claim 4, wherein said network is at least a portion of the global, public Internet.

6. The system of claim 5, wherein communications between said server and said plurality of users and said plurality of attorneys is via at least one of: video conferencing, VoIP telephone; chat; and email.

7. The system of claim 6, wherein the information stored in said database includes, for each of said plurality of attorneys, at least a geographic location and a legal specialty.

8. A computer program product comprising a computer usable medium having control logic stored therein for causing a computer to facilitate the operations of a virtual professional service organization, said control logic comprising:
first computer readable program code means for causing the computer to provide, over a network, a graphical user interface to a plurality of users;
second computer readable program code means for causing the computer to receive an input from one of said plurality of users, over said network and via said graphical user interface, said input indicative of at least a legal field and a jurisdiction;
third computer readable program code means for causing the computer to search a database containing information about a plurality of attorneys, wherein the results of said search is at least one of said plurality of attorneys licensed in said jurisdiction and having expertise in said legal field; and
fourth computer readable program code means for causing the computer to facilitate communications, over said network and via said graphical user interface, between said one of said plurality of users and said one of said plurality of attorneys.
